(19) United States
(12) Patent Application Publication
(10) Pub. No.: US 2015/0156839 A1
(43) Pub. Date: Jun. 4, 2015

(54) METHOD AND APPARATUS FOR ADJUSTING COLOR TEMPERATURE OF LUMINANCE OF LAMP

(71) Applicant: National Formosa University, Yunlin County (TW)

(72) Inventors: YU-KAI CHEN, Yunlin County (TW); CHAU-CHUNG SONG, Chiayi City (TW); YUNG-CHUN WU, Kaohsiung City (TW); CHIN-HSIUNG CHANG, Taichung City (TW)

(21) Appl. No.: 14/556,965

(22) Filed: Dec. 1, 2014

(30) Foreign Application Priority Data
Dec. 4, 2013 (TW) 102144328

(51) Int. Cl. H05B 33/08

(52) U.S. Cl. CPC H05B 33/0815; H05B 33/0845; H05B 33/0857

(57) ABSTRACT

A method and an apparatus for adjusting color temperature or luminance of lamp are provided in the present invention. The lamp at least includes a white light and a warm white light, and the method includes the steps of: providing a control interface circuit, which is configured at the position of the lamp switch on the wall, wherein the control interface circuit receives an AC signal and outputs a phase chopping signal according to a user's operation; asymmetrically cutting the AC signal to obtain the phase chopping signal when the user uses the control interface circuit to adjust a luminance and/or a color temperature. When the lamp receives the phase chopping signal, the method further comprises: determining whether a positive half cycle of the phase chopping signal and/or the negative half cycle of the phase chopping signal is chopped or not; adjusting the luminance of the white light and the warm white light of the lamp according to the on-time of the positive half cycle and the on-time of the negative half cycle of the phase chopping signal, such that the luminance and/or the color temperature is adjusted.

This application claims priority of No. 102144328 filed in Taiwan R.O.C. on Dec. 4, 2013 under 35 USC 119, the entire content of which is hereby incorporated by reference.

### BACKGROUND OF THE INVENTION

1. Field of Invention

The present invention relates to the technology of the lamp control method, and more particularly to a method and an apparatus for adjusting color temperature or luminance of a lamp.

2. Related Art

Lighting equipment is an important equipment for a home or a public place. In the past, the main lighting equipment is incandescent bulb. Because the driving of the incandescent bulb is relatively simple, the luminance of the incandescent bulb can be adjusted by a variable resistor. However, 90% of energy received by the incandescent bulb would be converted to a useless heat, and less than 10% of the energy received by the incandescent bulb would be transferred into light. Comparing with the incandescent bulb, the efficiency of a fluorescent lamp is quite better; it is close to 40%. The heat generated by the fluorescent lamp is about one sixth of the heat generated by the incandescent bulb. Because less than 10% of the energy an incandescent bulb is given off light, more and more places have begun to phase out the incandescent bulbs. The incandescent bulbs are gradually replaced by fluorescent lamps or the LED lamps. The small scale fluorescent lamps, such as the energy-saving light bulb, combines the fluorescent and the electrical starter, and is adopted for a standard lamp cap to be used for replacing a common incandescent bulb.

However, the spectrum of the incandescent bulb, including Halogen lamp, is continuous and average, it has best color rendering index (CRI). However, the emitting light of the fluorescent lamp and the LED lamp is discrete spectrum, they have low CRI. CRI represents the ability of a light source for revealing the colors of various objects faithfully in comparison with an ideal or natural light source. Low CRI light source would not only let people feel bad color, but also damage the health and eyesight. Conventional incandescent bulb also has the advantages of dimmability, great counting of switching times, and mercury free.

Currently, industry also introduces the dimmable LED lamp. The issue of the dimmable LED lamp is that it must have extra control circuit. FIG. 1 illustrates a configuration diagram depicting an electric wiring plan of a luminance adjustable LED lamp according to a conventional art. Referring to FIG. 1, the configuration diagram includes a live wire L, a neutral wire N, a lamp 101, a lamp connection wire 102, a lamp switch SW, interface circuit 104 and a control wire 103. User controls the driving circuit in the lamp 101 to control the fluorescent lamp or the LED lamp through the interface circuit 104. However, people having ordinary skill in the art should know that the extra control wire 103 should be configured in the wall for setting the interface circuit 104. The disadvantage of the configuration is not only the complexity of the wiring, but also has safety issue since the control wire 103 and its coupled interface circuit 104 belongs to weak current. If the control wire 103 is disposed with the lamp connection wire 102 in the same pipe, it may have safety concern.

In response to these problems, a solution is provided in the conventional art, the solution is to use wireless remote control. The solution can achieve to reduce the wiring. However, it must have an extra wireless emitter, and the lamp must have an extra wireless receiver. These design would cause overprice of the lamp.

### SUMMARY OF THE INVENTION

It is therefore an objective of the present invention to provide a luminance/color temperature adjustable lamp and a method for adjusting luminance/color temperature to adjust luminance/color temperature without changing or rewiring the wire embedded in the wall.

To achieve the above-identified or other objectives, the present invention provides an method for adjusting luminance/color temperature of a lamp, wherein the lamp has at least a first color lamp and a second color lamp, wherein the method comprises: providing a control interface circuit, wherein the control interface circuit is disposed on a mounting hole of the lamp switch, wherein the control interface circuit receives an AC signal to output a phase chopping signal according to a user's operation; symmetrically chopping the AC signal to obtain the phase chopping signal when a user uses the control interface circuit to adjust a luminance of the lamp, wherein an on-time of a positive half cycle the phase chopping signal is equal to an on-time of a negative half cycle the phase chopping signal; asymmetrically chopping the AC signal to obtain the phase chopping signal when a user uses the control interface circuit to adjust a color temperature of the lamp, wherein an on-time of a positive half cycle the phase chopping signal is not equal to an on-time of a negative half cycle the phase chopping signal; wherein, when the lamp receives the phase chopping signal, the method comprises: determining whether the positive half cycle the phase chopping signal and the negative half cycle the phase chopping signal are chopped or not; determining whether the positive half cycle the phase chopping signal and the negative half cycle the phase chopping signal are symmetrical or not; adjusting the luminance of the lamp according to a proportion between an off-time and the on-time of the phase chopping signal when the positive half cycle of the phase chopping signal and the negative half cycle of the phase chopping signal are chopped and the phase chopping signal is symmetrically chopped; adjusting the luminance of the first color lamp and the luminance of the second color lamp to adjust the color temperature of the lamp according to a proportion between the on-time of the positive half cycle of the phase chopping signal and the on-time of the negative half cycle of the phase chopping signal when the positive half cycle of the phase chopping signal and the negative half cycle of the phase chopping signal are chopped and the phase chopping signal is asymmetrically chopped.

The present invention further provides a method for adjusting luminance/color temperature of a lamp, wherein the lamp has at least a first color lamp and a second color lamp, wherein the method comprises: providing a control interface circuit, wherein the control interface circuit is disposed on a mounting hole of the lamp switch, wherein the control interface circuit receives an AC signal to output a phase chopping signal according to a user's operation; chopping the AC signal to obtain a phase chopping signal when a user adjusts the luminance and/or the color temperature through the control interface circuit; wherein, when the lamp receives the phase chopping signal, the method comprises: determining whether a positive half cycle the phase chopping signal or a negative half cycle the phase chopping signal is chopped or not; adjusting the luminance of the first color lamp and the luminance of the second color lamp to respectively adjust the luminance and the color temperature of the lamp according to an on-time of the positive half cycle of the phase chopping signal and an on-time of the negative half cycle of the phase chopping signal when the positive half cycle of the phase chopping signal is chopped or the negative half cycle of the phase chopping signal is chopped.

An adjustable lamp adapted for adjusting luminance/color temperature is also provided in the present invention. The adjustable lamp includes a lamp and a control interface circuit. The lamp is disposed on the lamp interface on a wall or a ceiling, and the lamp comprises a load circuit, a first color lamp and a second color lamp. The load circuit includes a first input terminal and a second input terminal, wherein the first input terminal of the load circuit is coupled to a first lamp connection line embedded in a wall, and the second input terminal of the load circuit is coupled to a second lamp connection line embedded in a wall. The first color lamp and the second color lamp is coupled to the load circuit. The control interface circuit includes an input terminal and an output terminal, wherein the input terminal is coupled to a first AC input terminal, and the output terminal of the control interface circuit is coupled to the first lamp connection line.

When a user adjusts the luminance through the control interface circuit, a AC signal is symmetrically chopped to obtain a phase chopping signal to output the phase chopping signal through the output terminal of the control interface circuit, wherein an on-time of a positive half cycle of the phase chopping signal is equal to an on-time of a negative half cycle of the phase chopping signal. when a user adjusts the color temperature through the control interface circuit, the AC signal is asymmetrically chopped to obtain the phase chopping signal to output the phase chopping signal through the output terminal of the control interface circuit, wherein the on-time of the positive half cycle of the phase chopping signal is not equal to the on-time of the negative half cycle of the phase chopping signal. When the lamp receives the phase chopping signal, the load circuit determines whether the positive half cycle and the negative half cycle of the phase chopping signal is chopped or not. When the positive half cycle of the phase chopping signal and the negative half cycle of the phase chopping signal are chopped and the phase chopping signal is symmetrically chopped, the load circuit adjusts the luminance of the lamp according to a proportion between an off-time and the on-time of the phase chopping signal. When the positive half cycle of the phase chopping signal and the negative half cycle of the phase chopping signal are chopped and the phase chopping signal is asymmetrically chopped, the load circuit adjusts the luminance of the first color lamp and the luminance of the second color lamp to adjust the color temperature of the lamp according to a proportion between the on-time of the positive half cycle of the phase chopping signal and the on-time of the negative half cycle of the phase chopping signal.

An adjustable lamp adapted for adjusting luminance/color temperature is also provided in the present invention. The adjustable lamp includes a lamp and a control interface circuit. The lamp is disposed on the lamp interface on a wall or a ceiling, and the lamp comprises a load circuit, a first color lamp and a second color lamp. The load circuit includes a first input terminal and a second input terminal, wherein the first input terminal of the load circuit is coupled to a first lamp connection line embedded in a wall, and the second input terminal of the load circuit is coupled to a second lamp connection line embedded in a wall. The first color lamp and the second color lamp is coupled to the load circuit. The control interface circuit includes an input terminal and an output terminal, wherein the input terminal is coupled to a first AC input terminal, and the output terminal of the control interface circuit is coupled to the first lamp connection line.

When a user adjusts the luminance and/or the color temperature through the control interface circuit, a AC signal is chopped to obtain a phase chopping signal to output the phase chopping signal through the output terminal of the control interface circuit. When the load circuit receives the phase chopping signal and when the positive half cycle of the phase chopping signal is chopped or the negative half cycle of the phase chopping signal is chopped, the load circuit adjusts the luminance of the first color lamp and the luminance of the second color lamp to respectively adjust the luminance and the color temperature of the lamp according to an on-time of the positive half cycle of the phase chopping signal and an on-time of the negative half cycle of the phase chopping signal.

The spirit of the present invention is to perform a waveform shaping to the AC signal to be transmitted to the lamp, and to utilize the load circuit in the lamp to perform a waveform interpretation to adjust the luminance and/or color temperature. For example, the positive half cycle of the AC signal represents the luminance of the white light, and the negative half cycle of the AC signal represents the luminance of the warm white light. Thus, user does not need to perform rewiring, and the original decoration can be preserved.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 illustrates a configuration diagram depicting an electric wiring plan of an luminance adjustable LED lamp according to a conventional art.

FIG. 2 illustrates a circuit diagram depicting a luminance/color temperature adjustable lamp according to a preferred embodiment of the present invention.

FIG. 3 illustrates a waveform diagram depicting an operation of a luminance/color temperature adjustable lamp according to a preferred embodiment of the present invention.

FIG. 4 illustrates a flowchart depicting a method for adjusting luminance/color temperature in the control interface circuit 21 according to a preferred embodiment of the present invention.

FIG. 5 illustrates a flowchart depicting a method for adjusting luminance/color temperature in the lamp 20 according to a preferred embodiment of the present invention.

FIG. 6 illustrates a waveform diagram depicting an operation of a luminance/color temperature adjustable lamp according to a preferred embodiment of the present invention.

FIG. 7 illustrates a flowchart depicting a method for adjusting luminance/color temperature in the control interface circuit 21 according to a preferred embodiment of the present invention.

FIG. 8 illustrates a flowchart depicting a method for adjusting luminance/color temperature in the lamp 20 according to a preferred embodiment of the present invention.

FIG. 9 illustrates a detail circuit diagram depicting the control interface circuit 21 and a part of load circuit 201 of the luminance/color temperature adjustable lamp according to a preferred embodiment of the present invention.

FIG. 10 illustrates a waveform diagram depicting an operation of the control interface circuit 21 of the luminance/color temperature adjustable lamp according to a preferred embodiment of the present invention.

FIG. 11 illustrates a diagram depicting an control panel PL according to a preferred embodiment of the present invention.

FIG. 12 illustrates a circuit diagram depicting a luminance/color temperature adjustable lamp according to a preferred embodiment of the present invention.

FIG. 13 illustrates a detail circuit diagram depicting the control interface circuit 121 and a part of lamp 120 of the luminance/color temperature adjustable lamp according to a preferred embodiment of the present invention.

FIG. 14 illustrates a waveform diagram depicting an operation the luminance/color temperature adjustable lamp according to a preferred embodiment of the present invention.

### DETAILED DESCRIPTION OF THE INVENTION

The present invention will be apparent from the following detailed description, which proceeds with reference to the accompanying drawings, wherein the same references relate to the same elements.

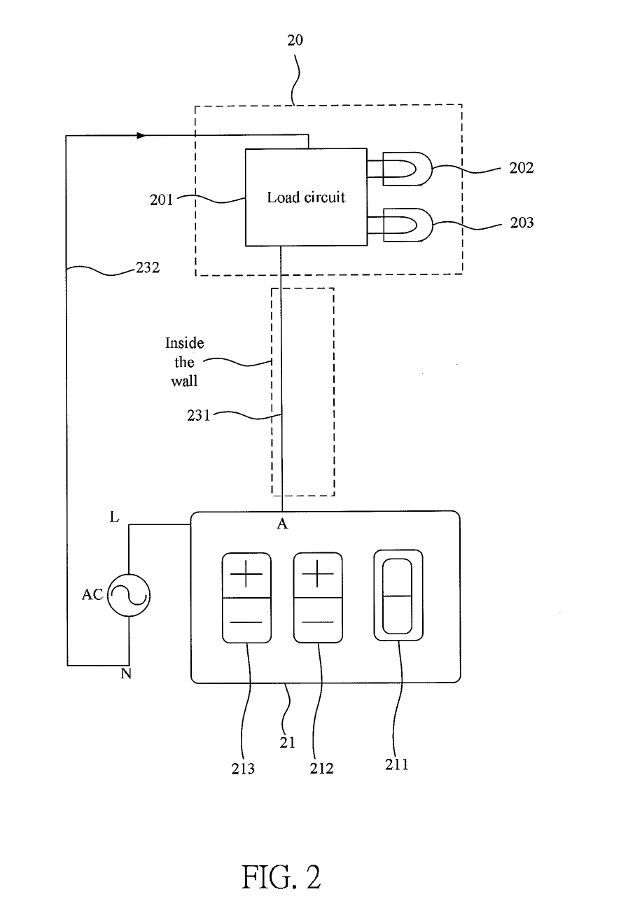

FIG. 2 illustrates a circuit diagram depicting a luminance/color temperature adjustable lamp according to a preferred embodiment of the present invention. Referring to FIG. 2, the luminance/color temperature adjustable lamp includes a lamp 20 and a control interface circuit 21. The lamp 20 is disposed on a lamp interface on a wall or a ceiling. The lamp 20 includes a load circuit 201, a first color lamp 202 and a second color lamp 203. The load circuit 201 is used for driving the first color lamp 202 and the second color lamp 203. The load circuit 201 is coupled to the first lamp connection line 231 and the second lamp connection line 232 of the lamp interface to receive the alternate current from the first lamp connection line 231 and the second lamp connection line 232 to light the lamp 20. In order to let people having ordinary skill in the art to understand the present invention, in this embodiment, it is assumed that the first color lamp 202 is a 6000K white LED lamp, and the second color lamp 203 is a 2300K warm white LED lamp.

The control interface circuit 21 is disposed in the light switch hole. Generally speaking, the control interface circuit 21 includes a lamp switch 211, a luminance control button 212, a color temperature control button 213 and its corresponding circuit (not shown). The control interface circuit 21 is coupled to the live wire L. In addition, the output terminal of the control interface circuit 21 is coupled to the first lamp connection line 231.

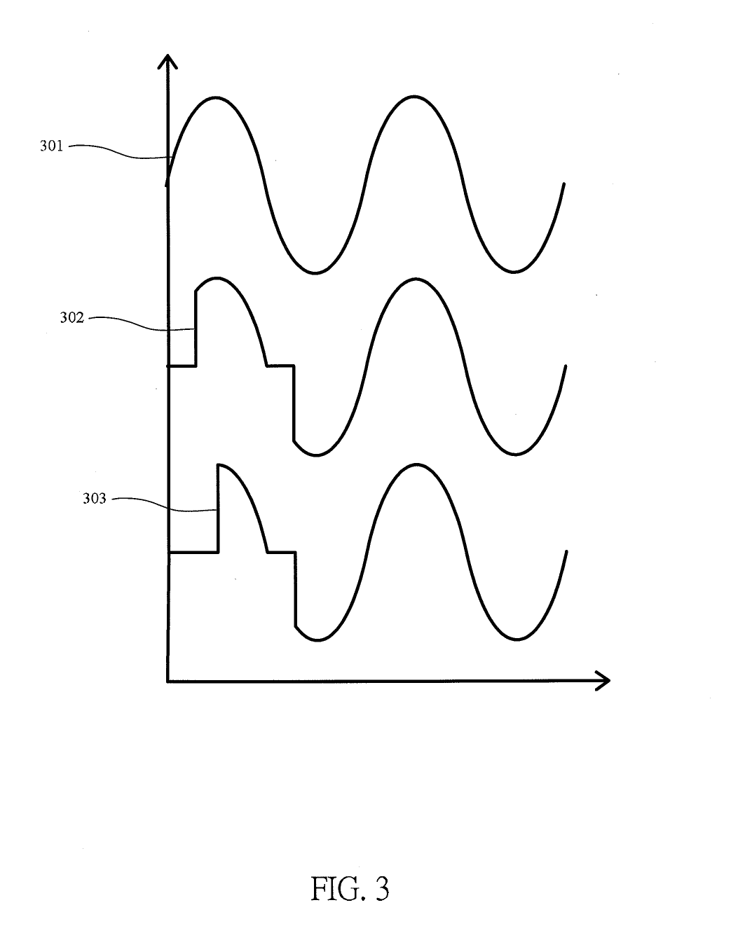

FIG. 3 illustrates a waveform diagram depicting an operation of a luminance/color temperature adjustable lamp according to a preferred embodiment of the present invention. Referring to FIG. 2 and FIG. 3, the waveform 301 represents the voltage of the node A when the color temperature and the luminance are not adjusted. The waveform 302 represents the voltage of the node A when the luminance is adjusted. The waveform 303 represents the voltage of the node A when the color temperature is adjusted. Referring to waveform 301, when the switch is turned on, the lamp 20 is turned on. The voltage of the node A is a 60 Hz sinusoidal wave.

When a user controls the luminance through the luminance button 212, the 60 Hz sinusoidal wave would be clipped by the control interface circuit 21. When the load circuit 201 receives the alternate current (AC), it would determine whether the AC is clipped or not. When the load circuit 201 determines that the AC of the node A is clipped, the load circuit 201 would determine the clipped AC in this period is the phase chopped signal for controlling the lamp. Next, the load circuit 201 determines whether the on time of the positive half cycle is equal to the on time of the negative half cycle. When the on time of the positive half cycle is equal to the on time of the negative half cycle, it represents the phase chopping signal for control the lamp is used for controlling the luminance. At this time, the load circuit 201 determines the luminance of the lamp according to the proportional between the off time and the on time. In addition, the load circuit 201 adjusts the luminance of the white LED lamp 202 and the warm white lamp 203 according to the adjusted luminance value.

When the user controls the color temperature through the color temperature control button 213, the 60 Hz sinusoidal wave would be clipped by the control interface circuit 21. When the load circuit 201 receives the alternate current (AC), it would determine whether the AC is clipped or not. When the load circuit 201 determines that the AC of the node A is clipped, the load circuit 201 would determine the clipped AC in this period is the phase chopped signal for controlling the lamp. Next, the load circuit 201 determines whether the on time of the positive half cycle is equal to the on time of the negative half cycle. When the on time of the positive half cycle is not equal to the on time of the negative half cycle, it represents the phase chopping signal for control the lamp is used for controlling the color temperature. At this time, the load circuit 201 determines the color temperature that the user adjusts according to the proportion between the on time of the positive half cycle and the on time of the negative half cycle. Moreover, the load circuit 201 adjusts the difference between the luminance of the white LED lamp 202 and the luminance of the warm white LED lamp 203 according to the adjusted color temperature value.

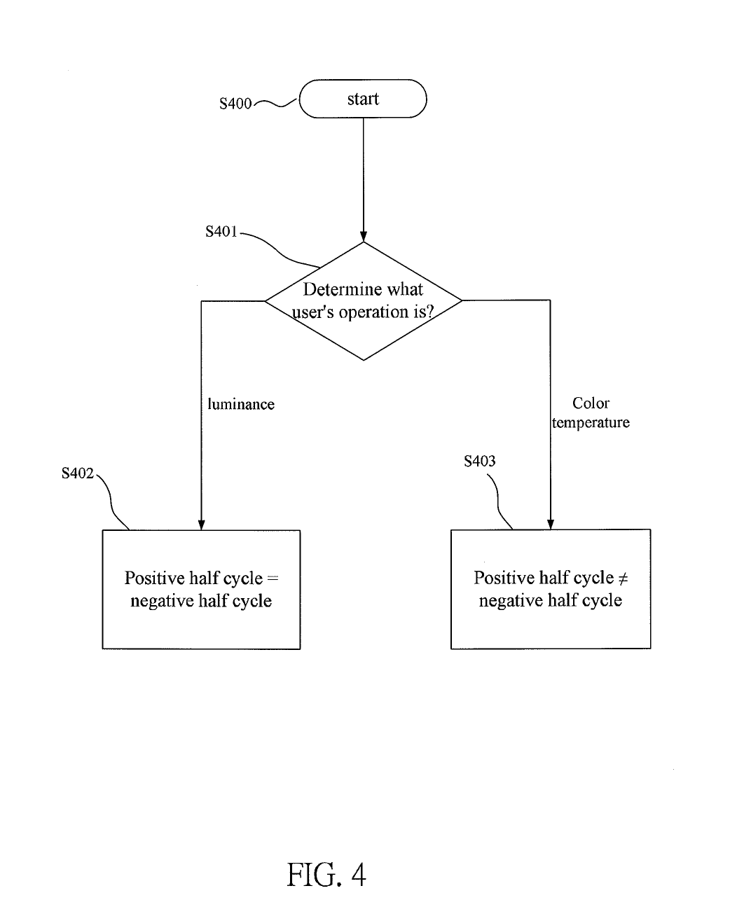

According to the abovementioned invention, a method for adjusting the color temperature or the luminance can be summarized. FIG. 4 illustrates a flowchart depicting a method for adjusting luminance/color temperature in the control interface circuit 21 according to a preferred embodiment of the present invention. Referring to FIG. 4, the method which the control interface 21 performs includes the steps as follow.

In step S400, the method starts.

In step S401, it is determined what a user's operation is. The step is for determining whether a user adjusts the luminance or the color temperature. When a user adjusts the luminance, the step S402 is performed. When a user adjusts the color temperature, the step S403 is performed.

In step S402, the phase chopping signal is outputted according to the luminance adjustment, wherein the on time of the positive half cycle of the phase chopping signal is equal to the on time of the negative half cycle of the phase chopping signal. When a user uses the control interface circuit 21 to adjust the luminance, the control interface circuit 21 outputs the phase chopping signal according to the luminance value which the user adjusted. Wherein on time of the positive half cycle of the phase chopping signal is equal to the on time of the negative half cycle of the phase chopping signal.

In step S403, the phase chopping signal is outputted according to the color temperature adjustment, wherein the on time of the positive half cycle of the phase chopping signal is not equal to the on time of the negative half cycle of the phase chopping signal. When a user uses the control interface circuit 21 to adjust the color temperature, the control interface circuit 21 outputs a asymmetric chopped AC to serve as the phase chopping signal according to the color temperature value which the user adjusted. Wherein on time of the positive half cycle of the phase chopping signal is not equal to the on time of the negative half cycle of the phase chopping signal.

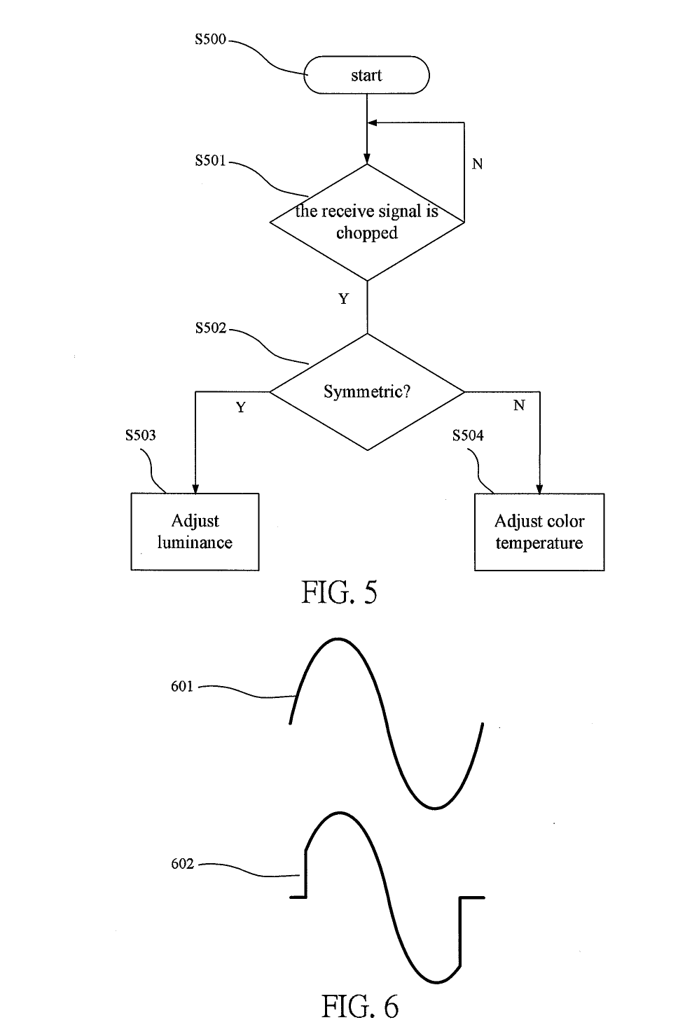

FIG. 5 illustrates a flowchart depicting a method for adjusting luminance/color temperature in the lamp 20 according to a preferred embodiment of the present invention. Referring to FIG. 5, the method that the lamp performs includes the steps as follows.

In step S500, the method starts.

In step S501, it is determined whether the positive half cycle and the negative half cycle of the received phase chopping signal is chopped. If it is negative, it represents that the received signal is a normal AC, and then go back to step S501. If it is positive, the step S502 is performed.

In step S502, it is determined whether the positive half cycle and the negative half cycle of the received phase chopping signal are symmetric or not. If it is positive, the step S503 is performed. If it is negative, the step S504 is performed.

In step S503, the luminance of the lamp is adjusted according to the proportion between the on time of the positive half cycle and the on time of the negative half cycle, when the positive half cycle and the negative half cycle of the received phase chopping signal are symmetric.

In step S504, the proportion between the luminance of the first color lamp and the luminance of the second color lamp is adjusted to adjust the color temperature of the lamp according to the proportion between the on time of the positive half cycle and the on time of the negative half cycle, when the positive half cycle and the negative half cycle of the received phase chopping signal are asymmetric.

In the abovementioned embodiments, a method for adjusting the luminance or the color temperature is provided. The following embodiment provides a different hardware to describe a different method for adjusting the luminance or the color temperature. It is assumed that the element 212 is a luminance control button for white LED lamp 202, and the element 213 is a luminance control button for warm white LED lamp 203.

FIG. 6 illustrates a waveform diagram depicting an operation of a luminance/color temperature adjustable lamp according to a preferred embodiment of the present invention. Referring to FIG. 6, the waveform 601 represents the voltage of the node A when the color temperature and the luminance are not adjusted. The waveform 602 represents the voltage of the node A when the luminance and/or the color temperature is/are adjusted. Referring to waveform 601, when the switch is turned on, the lamp 20 is turned on. The voltage of the node A is a 60 Hz sinusoidal wave.

When a user controls the luminance through the luminance button 212 for the white LED lamp 202, the 60 Hz sinusoidal wave would be clipped by the control interface circuit 21. When the load circuit 201 receives the alternate current (AC), it would determine whether the AC is clipped or not. When the load circuit 201 determines that the AC of the node A is clipped, the load circuit 201 would determine the received AC in this period is the phase chopped signal for control the lamp. Next, the load circuit 201 determines the on time of the positive half cycle and the on time of the negative half cycle, wherein the on time of the positive half cycle in this embodiment represents the luminance of the white LED lamp 202, and the on time of the negative half cycle in this embodiment represents the luminance of the warm white LED lamp 203. For example, it is assumed that the former setting that user gave is 90% luminance for the white LED lamp 202 and 80% luminance for the warm white LED lamp 203. When a user adjusts the luminance of the white LED lamp 202 to 70%, at this time, 30% of the positive half cycle is chopped (on time is 11.62 ms). In addition, since the luminance of the warm white LED lamp 203 is 80%, 20% of the negative half cycle is chopped. When the load circuit 201 receives the phase chopping signal, it would detects the on time of the positive half cycle of the phase chopping signal is 11.62 ms, and the on time of the negative half cycle of the phase chopping signal is 13.28 ms. Then, the load circuit 201 would adjust the luminance of the white LED lamp 202 to 70% and adjust the luminance of the warm white LED lamp 203 to 80%.

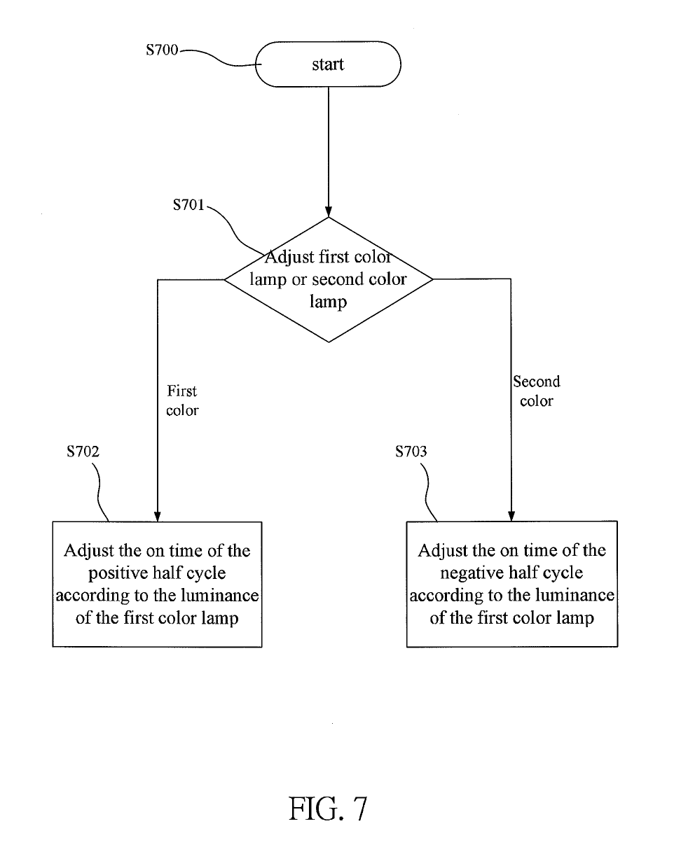

According to the abovementioned embodiment, a method for adjusting the luminance or the color temperature can be summarized. FIG. 7 illustrates a flowchart depicting a method for adjusting luminance/color temperature in the control interface circuit 21 according to a preferred embodiment of the present invention. Referring to FIG. 7, the method for adjusting luminance/color temperature in the control interface circuit 21 includes the step as follows.

In step S700, the method starts.

In step S701, it is determined a user's operation. It is determined whether a user adjusts the luminance of the first color lamp 202 or the luminance of the second color lamp 203. When the luminance of the first color lamp 202 is adjusted, the step S702 is performed. When the luminance of the second color lamp 203 is adjusted, the step S703 is performed.

In step S702, the on time of the positive half cycle of the phase chopping signal is adjusted according to the adjusted luminance value for the first color lamp 202, and the on time of the negative half cycle of the phase chopping signal is adjusted according to the former luminance setting for the second color lamp 203.

In step S703, the on time of the negative half cycle of the phase chopping signal is adjusted according to the adjusted luminance value for the second color lamp 203, and the on time of the positive half cycle of the phase chopping signal is adjusted according to the former luminance setting for the first color lamp 203.

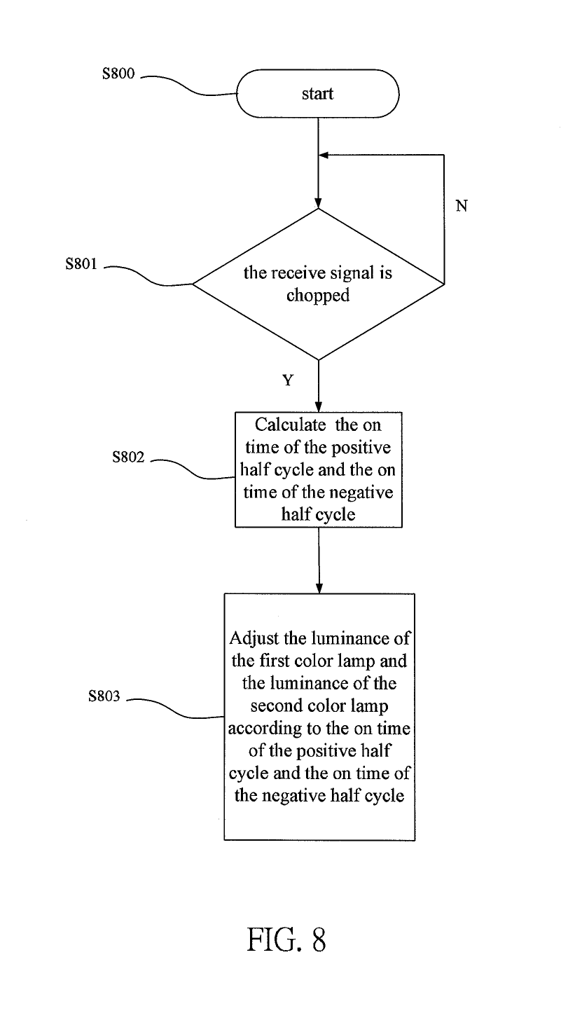

FIG. 8 illustrates a flowchart depicting a method for adjusting luminance/color temperature in the lamp 20 according to a preferred embodiment of the present invention. Referring to FIG. 8, the method for adjusting luminance/color temperature in the lamp 20 includes the steps as follow.

In step S800, the method starts.

In step S801, it is determined whether the positive half cycle and the negative half cycle of the received phase chopping signal is chopped If it is negative, it represents that the received signal is a normal AC, and then go back to step S801. If it is positive, the step S802 is performed.

In step S802, the on time of the positive half cycle of the received phase chopping signal and the on time of the negative half cycle of the received phase chopping signal are respectively calculated.

In step S803, the luminance of the first color lamp 202 and the luminance of the second color lamp 203 are respectively adjusted according to the on time of the positive half cycle of the phase chopping signal and the on time of the negative half cycle of the phase chopping signal. Thus, the luminance and the color temperature of the lamp 20 can be adjusted.

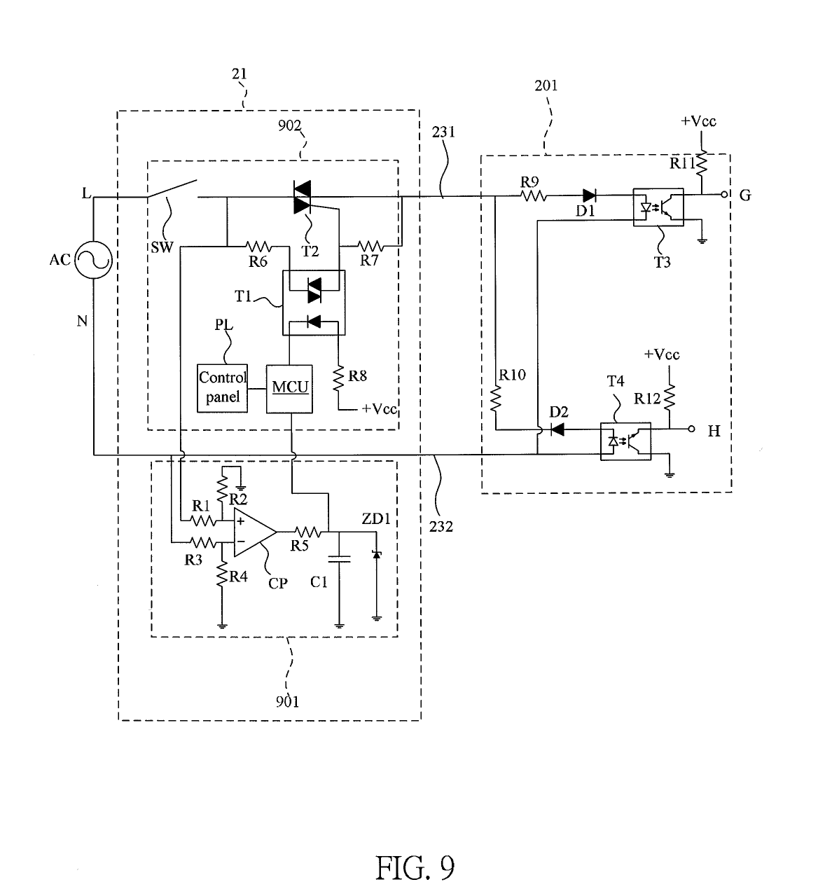

FIG. 9 illustrates a detail circuit diagram depicting the control interface circuit 21 and a part of load circuit 201 of the luminance/color temperature adjustable lamp according to a preferred embodiment of the present invention. Referring to FIG. 9, the control interface circuit 21 includes an AC period detector 901 and a phase chopping circuit 902. The AC period detector 901 is implemented by resistors R1˜R5, a capacitor C1, a zener diode ZD1 and a comparator CP, wherein the resistors R1 and R2 are used for dividing the voltage of the live wire L, and the resistors R3 and R4 are used for dividing the voltage of the neutral wire N, and the resistor R5 and the capacitor C1 are used for filtering before the signal outputs from the output terminal of the comparator CP, and the zener diode ZD1 is served as the voltage limiter circuit to limit the output voltage of the comparator (amplifier) CP. The output voltage of the comparator CP is a square wave. The phase and the period of the square wave is the same as those of AC.

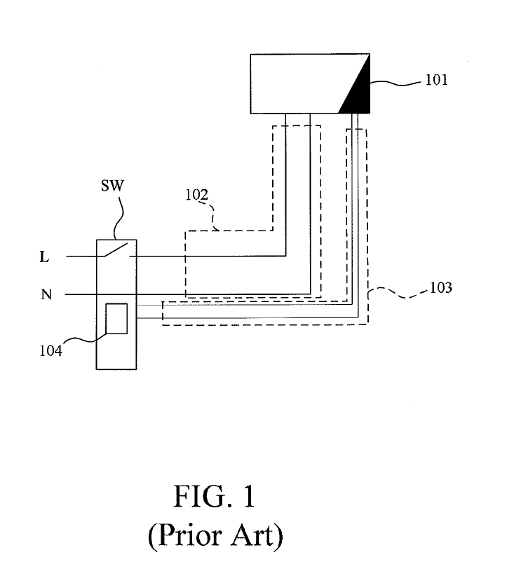

The phase chopping circuit 902 includes a control panel PL, a switch SW, a microcontroller MCU, resistors R6˜R8, a photo-coupler T1 and a tri-electrode AC switch (TRIAC) T2. The resistors R6 and R7 are served as a current limiter. The resistor R8 is served as a pull-high resistor. The microcontroller MCU receives the square wave from the comparator CP. Since a general microcontroller has PWM function, the microcontroller MCU can calculates the period and the phase of AC according to the square wave outputted from the comparator CP. The control panel PL can be the elements 212 and 213 as shown in FIG. 2 for example. User can control the luminance and color temperature through the control panel PL. When a user performs an operation through the control panel PL, the microcontroller MCU outputs the control pulse to the photo-coupler T1 according to the period and phase of AC and the luminance and color temperature that user adjusts (Referring to the embodiments and FIG. 1 to FIG. 8). When the photo-coupler T1 receives the control pulse with logic low voltage, the diode AC switch (DIAC) in the photo-coupler T1 is triggered and turned on. Thus, the TRIAC T2 is triggered and turned on.

The load circuit 201 includes resistors R9˜R12, diodes D1 and D2, and the photo-couplers T3 and T4. The resistors R9 and R10 are served as the current limiters for limiting the current respectively flowing through the photo-coupler T3 and T4. The diodes D1 and D2 are respectively for positive half wave rectifier and the negative half wave rectifier for the voltage between the first lamp connection line 231 and the second lamp connection line 232. The resistors R11 and R12 are served as pull-high resistors. When there is no current flowing through the photo-couplers T3 and T4, the node G and the node H are logic high voltage +Vcc. When the current of the positive half cycle passes through the photo-coupler T3, the collector of the photo-coupler T3 is shorted to the emitter of the photo-coupler T3. Thus, the node G is logic low voltage. When the current of the negative half cycle passes through the photo-coupler T4, the collector of the photo-coupler T4 is shorted to the emitter of the photo-coupler T4. Thus, the node H is logic low voltage.

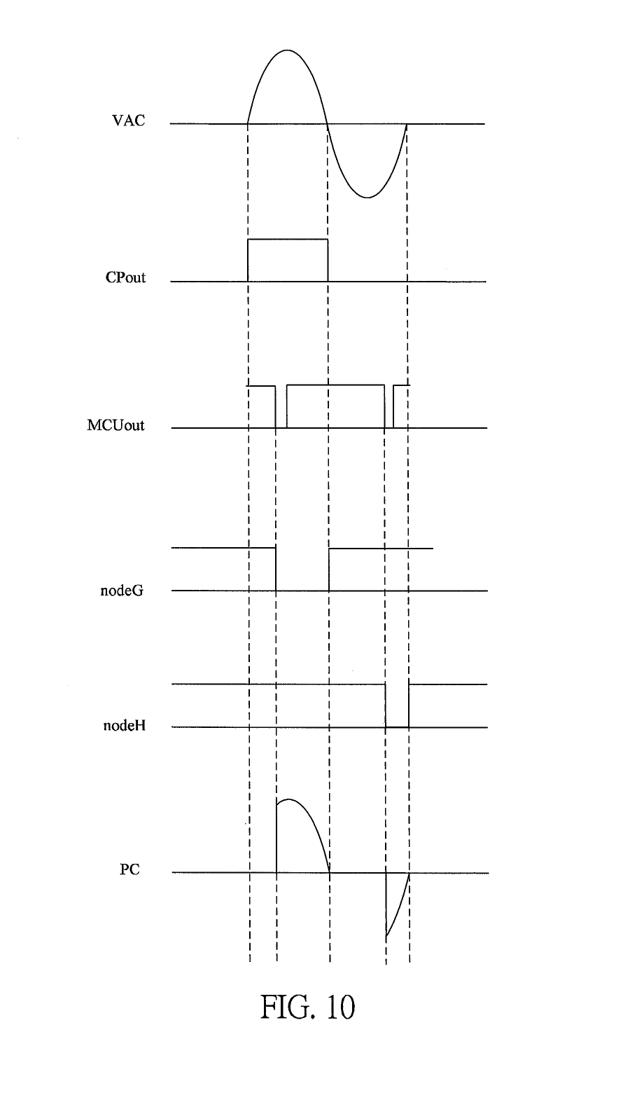

FIG. 10 illustrates a waveform diagram depicting an operation of the control interface circuit 21 of the luminance/color temperature adjustable lamp according to a preferred embodiment of the present invention. Referring to FIG. 9 and FIG. 10, the label VAC represents the waveform of AC voltage. The label CPout represents the square wave outputted from the comparator CP. The label MCUout represents the waveform depicting the pulse outputted from the microcontroller MCU. The label nodeG represents the waveform of the node G. The label nodeH represents the waveform of the node H. The label PC represents the waveform of the phase chopping signal. Adopting the first embodiment as an example, when a user adjusts the color temperature through the abovementioned control panel PL, the microcontroller MCU outputs the pulse signal MCUout according to the color temperature value that user adjusts. The pulse signal MCUout triggers the TRIAC T2 through the photo-coupler T1 such that the TRIAC T2 outputs the phase chopping signal PC, wherein the on time of positive half cycle of the phase chopping signal PC is not equal to the on time of negative half cycle of the phase chopping signal PC.

The resistor R9 and the diode D1 of the load circuit 201 performs the positive half wave rectifier to the voltage between the first lamp connection line 231 and the second lamp connection line 232, and outputs the rectified voltage to the photo-coupler T3. Thus, the pulse width of the voltage of the node G represents the on time of the positive half cycle of the phase chopping signal PC. Similarly, the resistor R10 and the diode D2 of the load circuit 201 performs the negative half wave rectifier to the voltage between the first lamp connection line 231 and the second lamp connection line 232, and outputs the rectified voltage to the photo-coupler T4. Thus, the pulse width of the voltage of the node H represents the on time of the negative half cycle of the phase chopping signal PC. The load circuit 201 detects the on time of the positive half cycle and the on time of the negative half cycle of the voltage between the first lamp connection line 231 and the second lamp connection line 232 by respectively detecting the pulse width of the voltage of the node G and the pulse width of the voltage of the node H. Therefore, the load circuit 201 adjusts the proportion between the luminance of the first color lamp and the luminance of the second color lamp according to the proportion between the on time of the positive half cycle and the on time of the negative half cycle of the phase chopping signal PC.

Similarly, taking the second embodiment as an example, when user adjusts the luminance of the warm white LED lamp 203, the microcontroller MCU outputs the pulse MCUout corresponding to the positive half cycle of the phase chopping signal according to the former luminance setting of the white LED lamp 202, and then the microcontroller MCU outputs the pulse MCUout corresponding to the negative half cycle of the phase chopping signal according to the user's luminance setting of the warm white LED lamp 203. The two pulses MCUout trigger the TRIAC T2 such that the TRIAC outputs the phase chopping signal PC

The resistor R9 and the diode D1 of the load circuit 201 performs the positive half wave rectifier to the voltage between the first lamp connection line 231 and the second lamp connection line 232, and outputs the rectified voltage to the photo-coupler T3. Thus, the pulse width of the voltage of the node G represents the on time of the positive half cycle of the phase chopping signal PC. Similarly, the resistor R10 and the diode D2 of the load circuit 201 performs the negative half wave rectifier to the voltage between the first lamp connection line 231 and the second lamp connection line 232, and outputs the rectified voltage to the photo-coupler T4. Thus, the pulse width of the voltage of the node H represents the on time of the negative half cycle of the phase chopping signal PC.

The load circuit 201 detects the on time of the positive half cycle and the on time of the negative half cycle of the voltage between the first lamp connection line 231 and the second lamp connection line 232 by respectively detecting the pulse width of the voltage of the node G and the pulse width of the voltage of the node H. Therefore, the load circuit 201 adjusts the luminance of the white LED lamp 202 according to on time of the positive half cycle of the phase chopping signal PC, and the load circuit 201 adjusts the luminance of the warm white LED lamp 203 according to on time of the negative half cycle of the phase chopping signal PC. As such, the luminance and the color temperature can be adjusted at the same time.

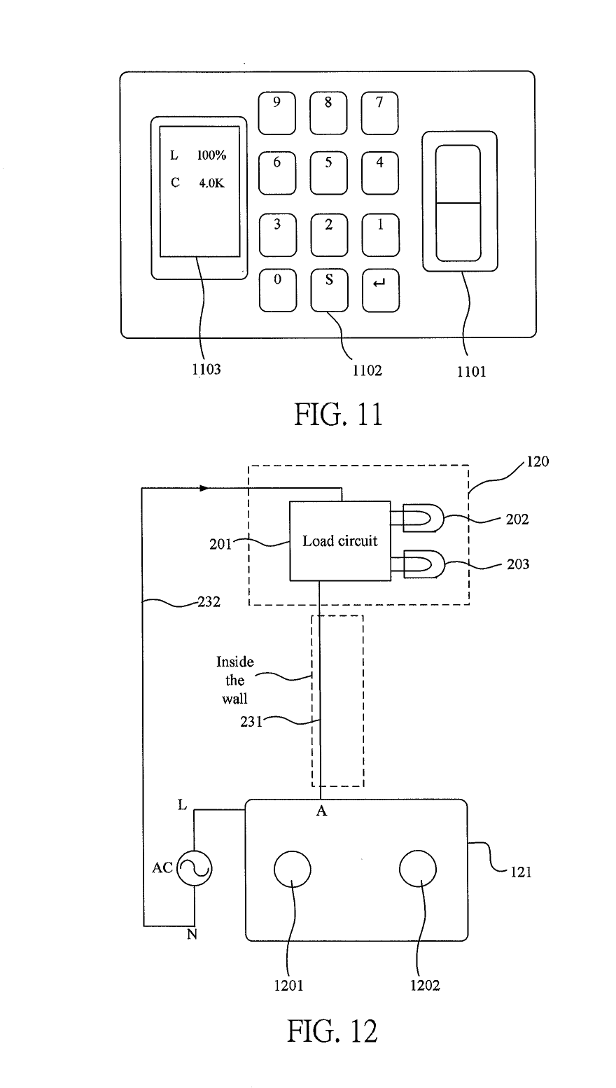

In the abovementioned embedment, the luminance control button/the luminance control button is for white LED lamp 202 and the color temperature control button/the luminance control button is for warm white LED lamp 203 are implemented by buttons. People having ordinary skill in the art should know that the design of the control panel PL can not only be implemented by buttons, but also can be implemented by a numeric keypad with liquid crystal display (LCD), as shown in FIG. 11. FIG. 11 illustrates a diagram depicting a control panel PL according to a preferred embodiment of the present invention. Referring to FIG. 11, the control panel PL includes a lamp switch 1101, a numeric keypad 1102 and an LCD 1103. The lamp switch 1101 is used to turn on/off the power of the lamp 20. The numeric keypad 1102 is used for controlling the luminance and the color temperature. The LCD 1103 is used for displaying the luminance and the color temperature. The luminance L is represented by percentage, and the color temperature C is represented by absolute temperature K. In addition to the LCD for displaying the luminance and the color temperature, people having ordinary skill in the art may adopt seven-segment display. Thus, the present invention is not limited to the abovementioned control panel PL.

FIG. 12 illustrates a circuit diagram depicting a luminance/color temperature adjustable lamp according to a preferred embodiment of the present invention. Referring to FIG. 12, the luminance/color temperature adjustable lamp also includes a lamp 120 and a control interface circuit 121. The lamp 120 also includes a load circuit 201, a first color lamp 202 and a second color lamp 203. The load circuit 201 is used for driving the first color lamp 202 and the second color lamp 203. The load circuit 201 is coupled to the first lamp connection line 231 and the second lamp connection line 232 to receive AC from the first lamp connection line 231 and the second lamp connection line 232. Similarly, in this embodiment, it is assumed the first color lamp 202 is 6000K white LED lamp, and the second color lamp 203 is 2300K warm white LED lamp.

The control interface circuit 121 is disposed in the light switch hole. Generally speaking, the control interface circuit 121 includes a luminance control knob 1201, a color temperature control knob 1202 and its corresponding circuit (not shown in FIG. 12). The control interface circuit 121 is coupled to the live wire L. In addition, the output terminal of the control interface circuit 21 is coupled to the first lamp connection line 231. In addition, it is assumed that the luminance control knob 1201 can be also used for turning on/off the lamp 120.

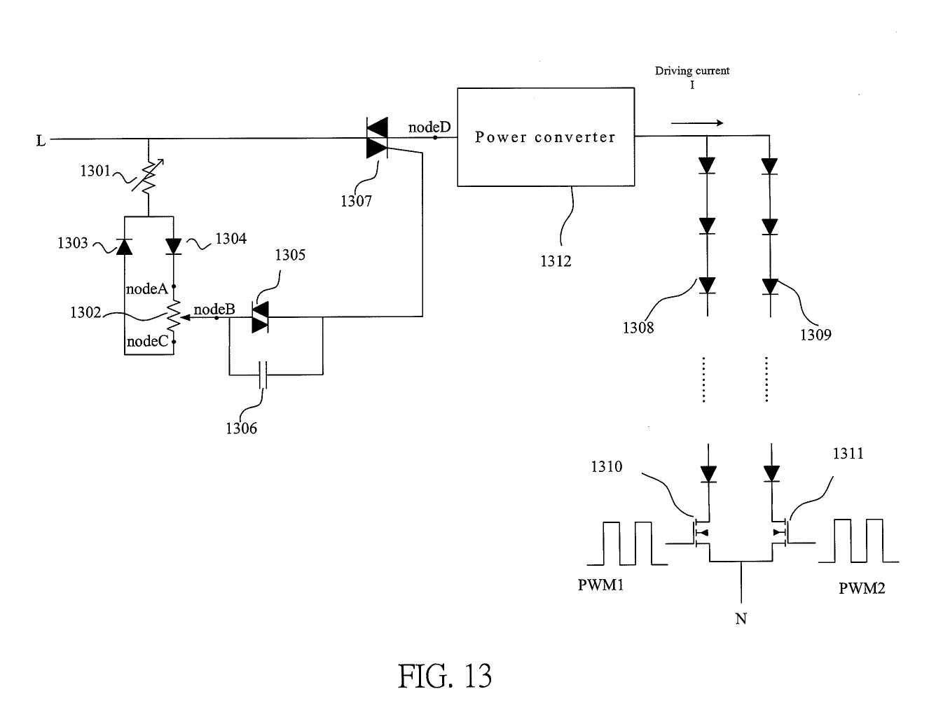

FIG. 13 illustrates a detail circuit diagram depicting the control interface circuit 121 and a part of lamp 120 of the luminance/color temperature adjustable lamp according to a preferred embodiment of the present invention. Referring to FIG. 13, the control interface circuit 121 includes a first variable resistor 1301, a second variable resistor 1302, a first unidirectional conduction element 1303, a second unidirectional conduction element 1304, a DIAC 1305, a capacitor 1306 and a TRIAC 1307. Furthermore, the lamp 120 in this embodiment includes a warm white LED string 1308, a white LED string 1309, a first switch 1310, a second switch 1311 and the power converter 1312. In this embodiment, the luminance control knob 1201 control the impedance of the two terminals of the first variable resistor 1301. When the impedance of the first variable resistor 1301 is controlled to be infinity, the lamp 120 is turned off.

The color temperature control knob 1202 is used for control the second variable resistor 1302. In this embodiment, the second variable resistor has three nodes nodeA, nodeB and nodeC, wherein the R_{AB} represents the impedance between the node nodeA and the node nodeB, the R_{BC} represents the impedance between the node nodeB and the node nodeC, and the VR1 represents the impedance of the first variable resistor 1301. According to the circuit diagram, people having ordinary skill in the art should know that the on time of the positive half cycle is determined by the time constant according to the impedance VR1+R_{AB} and the capacitance of the capacitor 1306. Also, the on time of the negative half cycle is determined by the time constant according to the impedance VR1+R_{BC} and the capacitance of the capacitor 1306. Since the capacitance of the capacitor 1306 would not be changed, the on time of the positive half cycle is only determined by the impedance VR1+R_{AB}, and the on time of the negative half cycle is only determined by the impedance VR1+R_{BC}.

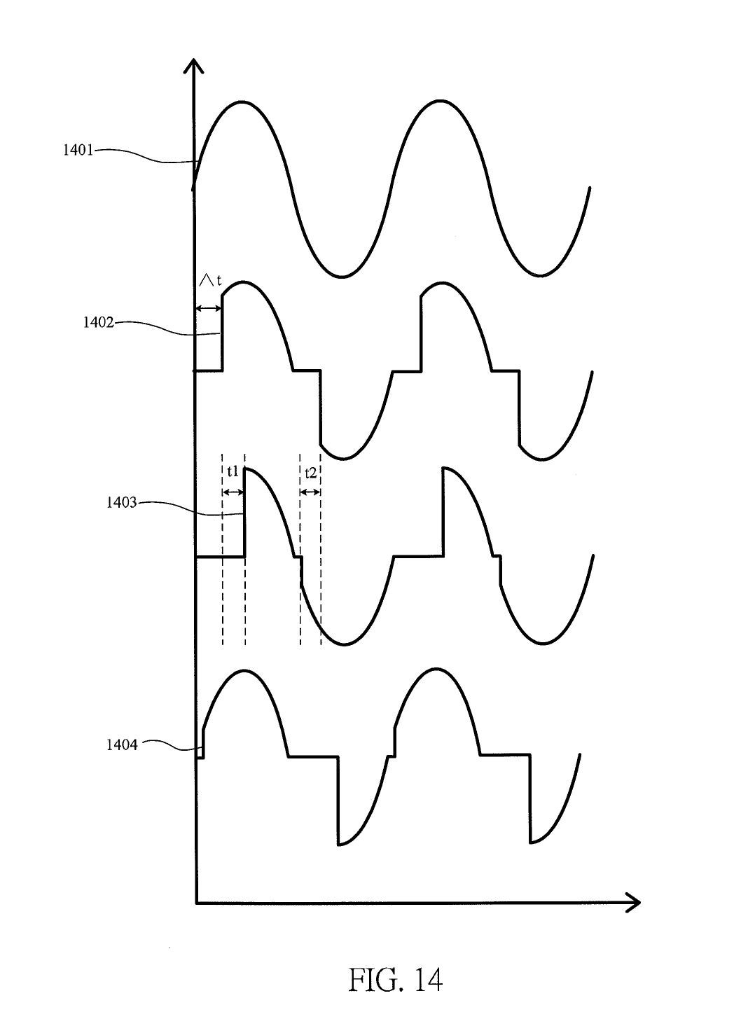

FIG. 14 illustrates a waveform diagram depicting an operation the luminance/color temperature adjustable lamp according to a preferred embodiment of the present invention. Referring to FIG. 13 and FIG. 14, the waveform 1401 represents the voltage of the live wire L. The waveform 1402 represents the voltage of the node D when the R_{AB} is equal to the R_{BC}. The waveform 1403 represents the voltage of the node D when the R_{AB} is greater than the R_{BC}. The waveform 1404 represents the voltage of the node D when the R_{AB} is smaller than the R_{BC}. Since the total impedance of the R_{AB} and R_{BC} would not be changed when the second variable resistor 1302 is adjusted, the sum of the on time of the positive half cycle and the on time of the negative half cycle is not changed in the perspective of an average of a period. And then the luminance is not changed. In addition, it is assumed that the time length of the on time of the positive half cycle represents the luminance of the warm white LED string 1308, and the on time of the negative half cycle represents the luminance of the white LED string 1309.

Moreover, in this embodiment, it is assumed that VR1 is far more than R_{AB} or R_{BC}. For example, when R_{AB} is equal to R_{BC}, the waveform of the voltage of the node nodeD is a symmetric waveform as shown in waveform 1402. At this time, the luminance of the white LED lamp is equal to the luminance of the warm white LED lamp, and the power converter 1312 outputs the pulse width modulation signals PWM1 and PWM2 according to the waveform of the voltage of the node nodeD, wherein the pulse width of the PWM1 is equal to the pulse width of PWM2. In other words, the magnitude of the impedance VR1 of the first variable resistor 1301 determines the magnitude of Δt. When R_{AB} is greater than R_{BC}, the waveform of the voltage of the node nodeD is an asymmetric waveform 1403. The power converter 1312 outputs the pulse width modulation signals PWM1 and PWM2 according to the waveform of the voltage of the node nodeD, wherein the pulse width of the PWM1 is smaller than the pulse width of PWM2. Thus, the warm white LED lamp becomes darker, and the white LED lamp becomes brighter. The duty cycle of the pulse width modulation signal PWM1 is represented as D−ΔD, and the duty cycle of the pulse width modulation signal PWM2 is represented as D+ΔD, wherein the difference of the duty cycle AD relates to the time t1 and the time t2. The greater time t1 and the time t2 is, the greater the difference of the duty cycle AD is. The power converter 1312 can respectively control the luminance of the warm white LED string 1308 and the luminance of the white LED string 1309 through controlling the conduction time of the first switch 1310 and the conduction time of the second switch 1311. As such, the adjustments of the luminance and the color temperature can be achieved.

In summary, the spirit of the present invention is to perform a waveform shaping to the AC signal, which is prepared for transmitting the lamp, and to utilize the load circuit in the lamp to perform a waveform detection to adjust the luminance and/or color temperature. For example, the positive half cycle of the AC signal represents the luminance of the white light, and the negative half cycle of the AC signal represents the luminance of the warm white light. Thus, user does not need to perform rewiring, and the original decoration can be preserved.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. An adjustable lamp, adapted for adjusting luminance/color temperature, comprising:
a lamp, disposed on a lamp interface on a wall or a ceiling, comprising:
a load circuit, comprising a first input terminal and a second input terminal, wherein the first input terminal of the load circuit is coupled to a first lamp connection line embedded in a wall, and the second input terminal of the load circuit is coupled to a second lamp connection line embedded in a wall;
a first color lamp, coupled to the load circuit; and
a second color lamp, coupled to the load circuit; and
a control interface circuit, comprising an input terminal and an output terminal, wherein the input terminal is coupled to a first AC input terminal, and the output terminal of the control interface circuit is coupled to the first lamp connection line,
wherein a AC signal is symmetrically chopped to obtain a phase chopping signal to output the phase chopping signal through the output terminal of the control interface circuit when a user adjusts the luminance through the control interface circuit, wherein an on-time of a positive half cycle of the phase chopping signal is equal to an on-time of a negative half cycle of the phase chopping signal,
wherein the AC signal is asymmetrically chopped to obtain the phase chopping signal to output the phase chopping signal through the output terminal of the control interface circuit when the user adjusts the color temperature through the control interface circuit, wherein the on-time of the positive half cycle of the phase chopping signal is not equal to the on-time of the negative half cycle of the phase chopping signal,
wherein the load circuit determines whether the positive half cycle and the negative half cycle of the phase chopping signal is chopped or not when the lamp receives the phase chopping signal,
wherein the load circuit adjusts the luminance of the lamp according to a proportion between an off-time and the on-time of the phase chopping signal when the positive half cycle of the phase chopping signal and the negative half cycle of the phase chopping signal are chopped and the phase chopping signal is symmetrically chopped,
wherein the load circuit adjusts the luminance of the first color lamp and the luminance of the second color lamp to adjust the color temperature of the lamp according to a proportion between the on-time of the positive half cycle of the phase chopping signal and the on-time of the negative half cycle of the phase chopping signal when the positive half cycle of the phase chopping signal and the negative half cycle of the phase chopping signal are chopped and the phase chopping signal is asymmetrically chopped.

2. The adjustable lamp according to claim 1, wherein the control interface circuit comprises:
a AC period detector, comprising a first input terminal, a second input terminal and an output terminal, wherein the first input terminal of the AC period detector is coupled to the first AC terminal, the second input terminal of the AC period detector is coupled to the second AC terminal, and the output terminal of the AC period detector is for outputting a period detecting square wave, wherein a period of the period detecting square wave is the same as a period of the AC signal; and
a phase chopping circuit, comprising an input terminal and an output terminal, wherein the input terminal of the phase chopping circuit is coupled to the first AC terminal, wherein the phase chopping circuit receives the period detecting square wave to determine the period of the AC signal, and the phase chopping circuit chops the AC signal to output the phase chopping signal according to the period of the AC signal and a user's operation.

3. The adjustable lamp according to claim 2, wherein the phase chopping circuit comprises:
a tri-electrode AC (TRIAC) switch, comprising an input terminal, an output terminal and a control terminal, wherein the input terminal of the TRIAC switch is coupled to the first AC terminal;
a first current limiting resistor, comprising a first terminal and a second terminal, wherein the first terminal of the first current limiting resistor is coupled to the first AC terminal;
a photo-coupler, comprising a first control terminal, a second control terminal, a first output terminal and a second output terminal, wherein the first output terminal of the photo-coupler is coupled to the first AC terminal, the second output terminal of the photo-coupler is coupled to the control terminal of the TRIAC switch, the second control terminal of the photo-coupler is coupled to a logic high voltage; and
a microprocessor, coupled to the first control terminal of the photo-coupler, wherein the microprocessor determines the phase of the AC signal according to the received period detecting square wave, and outputs a low voltage pulse according to the phase of the period detecting square wave and a user's operation, such that the output terminal of the TRIAC switch outputs the phase chopping signal.

4. The adjustable lamp according to claim 2, wherein the AC period detector comprises:
a first voltage divider, comprising an input terminal and an output terminal, wherein the input terminal of the first voltage divider is coupled to the first AC terminal, wherein the output terminal of the first voltage divider outputs a first divided voltage, wherein a voltage of the first divided voltage is proportional to a voltage of the first AC terminal;
a second voltage divider, comprising an input terminal and an output terminal, wherein the input terminal of the second voltage divider is coupled to the second AC terminal, wherein the output terminal of the second voltage divider outputs a second divided voltage, wherein a voltage of the second divided voltage is proportional to a voltage of the second AC terminal;
a comparator, comprising a first input terminal, a second input terminal and an output terminal, wherein the first input terminal of the comparator is coupled to the output terminal of the first voltage divider, and the second input terminal of the comparator is coupled to the output terminal of the second voltage divider;
a filtering circuit, comprising an input terminal and an output terminal, wherein the input terminal of the filtering circuit is coupled to the output terminal of the comparator, and the output terminal of the filtering circuit is coupled to the output terminal of the AC period detector; and
a voltage limiter circuit, comprising a first terminal and a second terminal, wherein the first terminal of the voltage limiter circuit is coupled to the output terminal of the AC period detector, and the second terminal of the voltage limiter circuit is coupled to a common voltage.

5. The adjustable lamp according to claim 4, wherein the first voltage divider comprises:
a first voltage dividing resistor, comprising a first terminal and a second terminal, wherein the first terminal of the first voltage dividing resistor is coupled to the first AC terminal; and
a second voltage dividing resistor, comprising a first terminal and a second terminal, wherein the first terminal of the second voltage dividing resistor is coupled to the second terminal of the first voltage dividing resistor and the second terminal of the second voltage dividing resistor is coupled to the common voltage;
wherein the second voltage divider comprises:
a third voltage dividing resistor, comprising a first terminal and a second terminal, wherein the first terminal of the third voltage dividing resistor is coupled to the second AC terminal;
a fourth voltage dividing resistor, comprising a first terminal and a second terminal, wherein the first terminal of the fourth voltage dividing resistor is coupled to the second terminal of the third voltage dividing resistor, and the second terminal of the fourth voltage dividing resistor is coupled to the common voltage.

6. The adjustable lamp according to claim 1, wherein the load circuit comprises:
a positive half cycle sampling circuit, comprising:
a first current limiting resistor, comprising a first terminal and a second terminal, wherein the first terminal of the first current limiting resistor receives the phase chopping signal;
a first unidirectional conductive element, comprising a first terminal and a second terminal, wherein the first terminal of the first unidirectional conductive element is coupled to the second terminal of the first current limiting resistor, wherein a current direction is from the first terminal of the first unidirectional conductive element to the second terminal of the first unidirectional conductive element;
a first photo-coupler, comprising a first control terminal, a second control terminal, a first output terminal and a second output terminal, wherein the first control terminal of the first photo-coupler is coupled to the second terminal of the first unidirectional conductive element, the second control terminal of the first photo-coupler is coupled to the second AC terminal, and the second output terminal of the first photo-coupler is coupled to a common voltage; and
a first pull high resistor, comprising a first terminal and a second terminal, wherein the first terminal of the first pull high resistor is coupled to a logic high voltage, and the second terminal of the first pull high resistor is coupled to the first output terminal of the first photo-coupler, wherein a pulse width of a voltage of the second terminal of the first pull high resistor represents the on-time of the positive half cycle of the phase chopping signal; and
a negative half cycle sampling circuit, comprising:
a second current limiting resistor, comprising a first terminal and a second terminal, wherein the first terminal of the second current limiting resistor receives the phase chopping signal;
a second unidirectional conductive element, comprising a first terminal and a second terminal, wherein the first terminal of the second unidirectional conductive element is coupled to the second terminal of the second current limiting resistor, wherein a current direction is from the second terminal of the second unidirectional conductive element to the first terminal of the second unidirectional conductive element;
a second photo-coupler, comprising a first control terminal, a second control terminal, a first output terminal and a second output terminal, wherein the first control terminal of the second photo-coupler is coupled to the second terminal of the second unidirectional conductive element, the second control terminal of the second photo-coupler is coupled to the second AC terminal, and the second output terminal of the second photo-coupler is coupled to the common voltage; and
a second pull high resistor, comprising a first terminal and a second terminal, wherein the first terminal of the second pull high resistor is coupled to the logic high voltage, and the second terminal of the second pull high resistor is coupled to the first output terminal of the second photo-coupler, wherein a pulse width of a voltage of the second terminal of the second pull high resistor represents the on-time of the negative half cycle of the phase chopping signal.

7. An adjustable lamp, adapted for adjusting luminance/color temperature, comprising:
a lamp, disposed on the lamp interface on a wall or a ceiling, comprising:
a load circuit, comprising a first input terminal and a second input terminal, wherein the first input terminal of the load circuit is coupled to a first lamp connection line embedded in a wall, and the second input terminal of the load circuit is coupled to a second lamp connection line embedded in a wall;
a first color lamp, coupled to the load circuit; and
a second color lamp, coupled to the load circuit; and
a control interface circuit, comprising an input terminal and an output terminal, wherein the input terminal is coupled to a first AC input terminal, and the output terminal of the control interface circuit is coupled to the first lamp connection line,
wherein a AC signal is chopped to obtain a phase chopping signal to output the phase chopping signal through the output terminal of the control interface circuit when a user adjusts the luminance and/or the color temperature through the control interface circuit;
wherein the load circuit adjusts the luminance of the first color lamp and the luminance of the second color lamp to respectively adjust the luminance and the color temperature of the lamp according to an on-time of the positive half cycle of the phase chopping signal and an on-time of the negative half cycle of the phase chopping signal when the load circuit receives the phase chopping signal and when the positive half cycle of the phase chopping signal is chopped or the negative half cycle of the phase chopping signal is chopped.

8. The adjustable lamp according to claim 7, wherein the control interface circuit comprises:
a AC period detector, comprising a first input terminal, a second input terminal and an output terminal, wherein the first input terminal of the AC period detector is coupled to the first AC terminal, the second input terminal of the AC period detector is coupled to the second AC terminal, and the output terminal of the AC period detector is for outputting a period detecting square wave, wherein a period of the period detecting square wave is the same as a period of the AC signal; and
a phase chopping circuit, comprising an input terminal and an output terminal, wherein the input terminal of the phase chopping circuit is coupled to the first AC terminal, wherein the phase chopping circuit receives the period detecting square wave to determine the period of the AC signal, and the phase chopping circuit chops the AC signal to output the phase chopping signal according to the period of the AC signal and a user's operation.

9. The adjustable lamp according to claim 8, wherein the phase chopping circuit comprises:
a tri-electrode AC (TRIAC) switch, comprising an input terminal, an output terminal and a control terminal, wherein the input terminal of the TRIAC switch is coupled to the first AC terminal;
a first current limiting resistor, comprising a first terminal and a second terminal, wherein the first terminal of the first current limiting resistor is coupled to the first AC terminal;
a photo-coupler, comprising a first control terminal, a second control terminal, a first output terminal and a second output terminal, wherein the first output terminal of the photo-coupler is coupled to the first AC terminal, the second output terminal of the photo-coupler is coupled to the control terminal of the TRIAC switch, the second control terminal of the photo-coupler is coupled to a logic high voltage; and
a microprocessor, coupled to the first control terminal of the photo-coupler, wherein the microprocessor determines the phase of the AC signal according to the received period detecting square wave, and outputs a low voltage pulse according to the phase of the period detecting square wave and a user's operation, such that the output terminal of the TRIAC switch outputs the phase chopping signal.

10. The adjustable lamp according to claim 8, wherein the AC period detector comprises:
a first voltage divider, comprising an input terminal and an output terminal, wherein the input terminal of the first voltage divider is coupled to the first AC terminal, wherein the output terminal of the first voltage divider outputs a first divided voltage, wherein a voltage of the first divided voltage is proportional to a voltage of the first AC terminal;
a second voltage divider, comprising an input terminal and an output terminal, wherein the input terminal of the second voltage divider is coupled to the second AC terminal, wherein the output terminal of the second voltage divider outputs a second divided voltage, wherein a voltage of the second divided voltage is proportional to a voltage of the second AC terminal;
a comparator, comprising a first input terminal, a second input terminal and an output terminal, wherein the first input terminal of the comparator is coupled to the output terminal of the first voltage divider, and the second input terminal of the comparator is coupled to the output terminal of the second voltage divider;
a filtering circuit, comprising an input terminal and an output terminal, wherein the input terminal of the filtering circuit is coupled to the output terminal of the comparator, and the output terminal of the filtering circuit is coupled to the output terminal of the AC period detector; and
a voltage limiter circuit, comprising a first terminal and a second terminal, wherein the first terminal of the voltage limiter circuit is coupled to the output terminal of the AC period detector, and the second terminal of the voltage limiter circuit is coupled to a common voltage.

11. The adjustable lamp according to claim 10, wherein the first voltage divider comprises:
a first voltage dividing resistor, comprising a first terminal and a second terminal, wherein the first terminal of the first voltage dividing resistor is coupled to the first AC terminal; and
a second voltage dividing resistor, comprising a first terminal and a second terminal, wherein the first terminal of the second voltage dividing resistor is coupled to the second terminal of the first voltage dividing resistor and the second terminal of the second voltage dividing resistor is coupled to the common voltage;
wherein the second voltage divider comprises:
a third voltage dividing resistor, comprising a first terminal and a second terminal, wherein the first terminal of the third voltage dividing resistor is coupled to the second AC terminal;
a fourth voltage dividing resistor, comprising a first terminal and a second terminal, wherein the first terminal of the fourth voltage dividing resistor is coupled to the second terminal of the third voltage dividing resistor, and the second terminal of the fourth voltage dividing resistor is coupled to the common voltage.

12. The adjustable lamp according to claim 7, wherein the load circuit comprises:
a positive half cycle sampling circuit, comprising:
a first current limiting resistor, comprising a first terminal and a second terminal, wherein the first terminal of the first current limiting resistor receives the phase chopping signal;
a first unidirectional conductive element, comprising a first terminal and a second terminal, wherein the first terminal of the first unidirectional conductive element is coupled to the second terminal of the first current limiting resistor, wherein a current direction is from the first terminal of the first unidirectional conductive element to the second terminal of the first unidirectional conductive element;
a first photo-coupler, comprising a first control terminal, a second control terminal, a first output terminal and a second output terminal, wherein the first control terminal of the first photo-coupler is coupled to the second terminal of the first unidirectional conductive element, the second control terminal of the first photo-coupler is coupled to the second AC terminal, and the second output terminal of the first photo-coupler is coupled to a common voltage; and
a first pull high resistor, comprising a first terminal and a second terminal, wherein the first terminal of the first pull high resistor is coupled to a logic high voltage, and the second terminal of the first pull high resistor is coupled to the first output terminal of the first photo-coupler, wherein a pulse width of a voltage of the second terminal of the first pull high resistor represents the on-time of the positive half cycle of the phase chopping signal; and
a negative half cycle sampling circuit, comprising:
a second current limiting resistor, comprising a first terminal and a second terminal, wherein the first terminal of the second current limiting resistor receives the phase chopping signal;
a second unidirectional conductive element, comprising a first terminal and a second terminal, wherein the first terminal of the second unidirectional conductive element is coupled to the second terminal of the second current limiting resistor, wherein a current direction is from the second terminal of the second unidirectional conductive element to the first terminal of the second unidirectional conductive element;
a second photo-coupler, comprising a first control terminal, a second control terminal, a first output terminal and a second output terminal, wherein the first control terminal of the second photo-coupler is coupled to the second terminal of the second unidirectional conductive element, the second control terminal of the second photo-coupler is coupled to the second AC terminal, and the second output terminal of the second photo-coupler is coupled to the common voltage; and
a second pull high resistor, comprising a first terminal and a second terminal, wherein the first terminal of the second pull high resistor is coupled to the logic high voltage, and the second terminal of the second pull high resistor is coupled to the first output terminal of the second photo-coupler, wherein a pulse width of a voltage of the second terminal of the second pull high resistor represents the on-time of the negative half cycle of the phase chopping signal.

13. The adjustable lamp according to claim 7, wherein the control interface circuit comprises:
a first knob, for adjusting the luminance;
a second knob, for adjusting the color temperature; and
a phase chopping circuit, comprising:
a first variable resistor, comprises a first terminal and a second terminal, wherein the first terminal of the first variable resistor is coupled to the first AC terminal and the first knob is used for adjusting an impedance between the first terminal of the first variable resistor and the second terminal of the first variable resistor;
a first unidirectional conductive element, comprising a first terminal and a second terminal, wherein the first terminal of the first unidirectional conductive element is coupled to the second terminal of the first variable resistor, wherein a current direction is from the first terminal of the first unidirectional conductive element to the second terminal of the first unidirectional conductive element;
a second unidirectional conductive element, comprising a first terminal and a second terminal, wherein the second terminal of the second unidirectional conductive element is coupled to the second terminal of the first variable resistor, wherein a current direction is from the first terminal of the second unidirectional conductive element to the second terminal of the second unidirectional conductive element;
a second variable resistor, comprises a first terminal, a second terminal and a third terminal, wherein the first terminal of the second variable resistor is coupled to the second terminal of the first unidirectional conductive element, and the third terminal of the second variable resistor is coupled to the first terminal of the second unidirectional conductive element, wherein the second knob is used for adjusting a proportion between an impedance between the first terminal of the second variable resistor and the second terminal of the second variable resistor and an impedance between the second terminal of the second variable resistor and the third terminal of the second variable resistor;
a capacitor, comprising a first terminal and a second terminal, wherein the first terminal of the capacitor is coupled to the second terminal of the second variable resistor;
a diode for AC (DIAC) switch, comprising a first terminal and a second terminal, wherein the first terminal of the DIAC switch is coupled to the second terminal of the second variable resistor;
a tri-electrode AC (TRIAC) switch, comprising an input terminal, an output terminal and a control terminal, wherein the input terminal of the TRIAC switch is coupled to the first AC terminal, the control terminal of the TRIAC switch is coupled to the second terminal of the capacitor and the second terminal of the DIAC switch, and the output terminal of the TRIAC switch is coupled to the first lamp connection line.

14. An method for adjusting luminance/color temperature of a lamp, wherein the lamp has at least a first color lamp and a second color lamp, wherein the method comprises:
providing a control interface circuit, wherein the control interface circuit is disposed on a mounting hole of the lamp switch, wherein the control interface circuit receives an AC signal to output a phase chopping signal according to a user's operation;
symmetrically chopping the AC signal to obtain the phase chopping signal when a user uses the control interface circuit to adjust a luminance of the lamp, wherein an on-time of a positive half cycle the phase chopping signal is equal to an on-time of a negative half cycle the phase chopping signal; and
asymmetrically chopping the AC signal to obtain the phase chopping signal when a user uses the control interface circuit to adjust a color temperature of the lamp, wherein the on-time of the positive half cycle the phase chopping signal is not equal to the on-time of the negative half cycle the phase chopping signal;
wherein, when the lamp receives the phase chopping signal, the method comprises:
determining whether the positive half cycle the phase chopping signal and the negative half cycle the phase chopping signal are chopped or not;
determining whether the positive half cycle the phase chopping signal and the negative half cycle the phase chopping signal are symmetrical or not;
adjusting the luminance of the lamp according to a proportion between an off-time and the on-time of the phase chopping signal when the positive half cycle of the phase chopping signal and the negative half cycle of the phase chopping signal are chopped and the phase chopping signal is symmetrically chopped; and
adjusting the luminance of the first color lamp and the luminance of the second color lamp to adjust the color temperature of the lamp according to a proportion between the on-time of the positive half cycle of the phase chopping signal and the on-time of the negative half cycle of the phase chopping signal when the positive half cycle of the phase chopping signal and the negative half cycle of the phase chopping signal are chopped and the phase chopping signal is asymmetrically chopped.

15. An method for adjusting luminance/color temperature of a lamp, wherein the lamp has at least a first color lamp and a second color lamp, wherein the method comprises:
providing a control interface circuit, wherein the control interface circuit is disposed on a mounting hole of the lamp switch, wherein the control interface circuit receives an AC signal to output a phase chopping signal according to a user's operation;
chopping the AC signal to obtain a phase chopping signal when a user adjusts the luminance and/or the color temperature through the control interface circuit;
wherein, when the lamp receives the phase chopping signal, the method comprises:
determining whether a positive half cycle the phase chopping signal or a negative half cycle the phase chopping signal is chopped or not;
adjusting the luminance of the first color lamp and the luminance of the second color lamp to respectively adjust the luminance and the color temperature of the lamp according to an on-time of the positive half cycle of the phase chopping signal and an on-time of the negative half cycle of the phase chopping signal when the positive half cycle of the phase chopping signal is chopped or the negative half cycle of the phase chopping signal is chopped.
